(19) United States
(12) Patent Application Publication
(10) Pub. No.: US 2015/0291862 A1
(43) Pub. Date: Oct. 15, 2015

(54) NON-ISOCYANATE SEALANT FOR GLASS SEALING

(71) Applicant: DOW GLOBAL TECHNOLOGIES LLC, Midland, MI (US)

(72) Inventors: Bindu Krishnan, Lake Jackson, TX (US); Phillip S. Athey, Lake Jackson, TX (US); William Heath, Lake Jackson, TX (US); Harshad M. Shah, Missouri City, TX (US)

(21) Appl. No.: 14/648,637

(22) PCT Filed: Dec. 18, 2013
(86) PCT No.: PCT/US2013/076238

§ 371 Date: May 29, 2015

Related U.S. Application Data
(60) Provisional application No. 61/745,517, filed on Dec. 21, 2012.

(51) Int. Cl. C09J 163/10; E06B 3/56; B32B 7/14; B32B 37/12; C03C 27/10; B32B 17/06

(52) U.S. Cl. CPC C09J 163/10; C03C 27/10; B32B 17/06; B32B 7/14; B32B 37/1284; E06B 3/56; B32B 2605/00; B32B 2419/00; B32B 2307/304; B32B 2037/1253

(57) ABSTRACT

Elastomeric sealants for sealing glass to a substrate are prepared by applying a curable reaction mixture between glass and substrate, and curing the mixture. The curable reaction mixture contains a polyene compound, an epoxy resin, a thiol curing agent and a basic catalyst. The polyene compound has an average of at least two groups containing aliphatic carbon-carbon double bonds capable of reaction with a thiol group. At least one of said aliphatic carbon-carbon double bonds is separated from each other said aliphatic carbon-carbon double bond by an aliphatic spacer group having a weight of at least 500 atomic mass units.

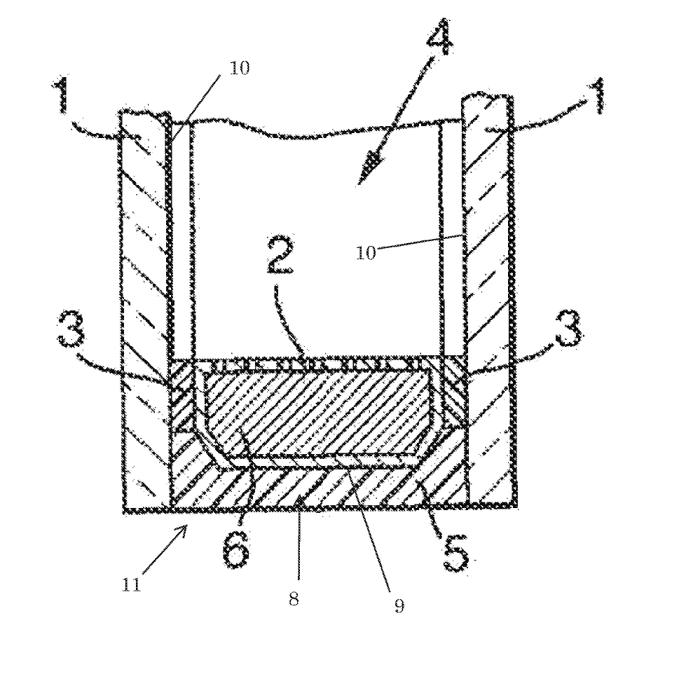

This invention relates to a non-isocyanate sealant for glass sealing, to a method of sealing glass surfaces, to a method for making insulated glass units and to insulated glass units sealed with a non-isocyanate sealant.

Sealants are often applied to glass windows to prevent gas and water leakage around the edges. Such sealants are used, for example, to seal the edges of insulating glass units (IGUs). IGUs generally comprise two or more parallel glass panes held a small distance apart by a spacer. The space between the panes is filled with air or an inert gas such as argon. In IGUs, the sealant serves the purpose of holding the unit together, providing a barrier for the loss of inert gases and preventing permeation of water into the unit which would result in fogging.

Another common application for glass sealants is in automotive windshields, in which a bead of sealant is commonly used to bond the glass to the vehicle frame and seal the edges.

The general requirements for these materials are that they are elastomeric, they bond well to glass and other materials, and they form good barriers to the penetration of gases and liquids.

Thermosetting polymers are often the materials of choice for these applications, because they can be applied at ambient temperatures in the form of liquid or pastes that cure in place to form the sealant. The most common types of elastomeric glass sealants are polysulfides, polyurethanes and silicones. All have their drawbacks. There are environmental and toxicological issues associated with the polysulfides, associated in particular with the presence of thiram and/or manganese dioxide in those formulations. One-part polyurethanes often rely on a moisture cure, which can be quite slow and can result in foaming. Two-part polyurethanes offer excellent long-term performance and form excellent moisture vapor barriers, but have certain processing disadvantages. A large difference in the viscosities of the two components leads to mixing difficulties, so special mixing equipment often is needed. The curing profile and product properties are highly sensitive to mix ratios, and the curing profile can vary considerably with temperature. In addition, the polyurethane types contain isocyanate compounds that present worker exposure concerns if the materials are not handled properly. Silicone sealants have excellent weatherability, but have very high permeability towards gases and vapors and hence find application only in a dual-seal insulation unit, in which another material forms the gas and vapor barrier.

Therefore, it would be desirable to provide a thermosetting, elastomeric sealant for glass installations, which sealant has good processing characteristics, exhibits good adhesion to glass, provides the needed barrier to gasses and liquids (including atmospheric moisture) and which has the necessary physical properties.

This invention is in one aspect a process for forming a seal between glass and a substrate, comprising:

a) forming a reaction mixture containing 1) at least one polyene compound having an average of at least two groups containing aliphatic carbon-carbon double bonds capable of reaction with a thiol group, wherein at least one of such aliphatic carbon-carbon double bonds is separated from each other such aliphatic carbon-carbon double bond by an aliphatic spacer group having a weight of at least 1000 atomic mass units, 2) from 20 to 150 parts by weight, per 100 parts by weight of component 1), of at least one epoxy resin having an average of at least two epoxide groups per molecule and an epoxy equivalent weight of up to 1000, 3) at least one curing agent having an average of at least 1.5 thiol groups per molecule, and 4) at least one basic catalyst,

b) applying the reaction mixture to an interface between and in contact with said glass and said substrate;

c) curing the reaction mixture to form an elastomeric seal between the glass and the substrate.

In specific embodiments, the invention is a process for producing an edge seal for a multi-pane glass assembly, wherein the multi-pane glass assembly comprises at least one pair of substantially parallel glass sheets, the glass sheets of said pair being separated from each other by one or more spacers positioned between the pair of glass sheets at or near at least one edge of the glass sheets; the process comprising

a) applying a curable reaction mixture to said at least one edge of the pair of glass sheets and into contact with each of the pair of glass sheets and the spacer(s) separating said pair of glass sheets and

b) curing the curable reaction mixture to form an elastomeric edge seal between the pair of glass sheets and adherent to the spacer(s) separating the pair of glass sheets;

wherein the curable reaction mixture contains 1) at least one polyene compound having an average of at least two groups containing aliphatic carbon-carbon double bonds capable of reaction with a thiol group, wherein at least one of such aliphatic carbon-carbon double bonds is separated from each other such aliphatic carbon-carbon double bond by an aliphatic spacer group having a weight of at least 1000 atomic mass units, 2) from 20 to 150 parts by weight, per 100 parts by weight of component 1), of at least one epoxy resin having an average of at least 1.5 epoxide groups per molecule and an epoxy equivalent weight of up to 1000, 3) at least one curing agent having at least two thiol groups, and 4) at least one basic catalyst.

The invention is also a multi-pane glass assembly comprising at least one pair of substantially parallel glass sheets, the glass sheets of said pair being separated from each other by one or more spacers positioned between the pair of glass sheets at or near at least one edge of the glass sheets, and an elastomeric edge seal bonded to said edge of the glass sheets and the spacer(s),

wherein the elastomeric edge seal is a polymer formed by curing a curable reaction mixture containing 1) at least one polyene compound having an average of at least two groups containing aliphatic carbon-carbon double bonds capable of reaction with primary amine, secondary amine and/or a thiol group, wherein at least one of such aliphatic carbon-carbon double bonds is separated from each other such aliphatic carbon-carbon double bond by an aliphatic spacer group having a weight of at least 1000 atomic mass units, 2) from 20 to 150 parts by weight, per 100 parts by weight of component 1), of at least one epoxy resin having an average of at least 1.5 epoxide groups per molecule and an epoxy equivalent weight of up to 1000, 3) at least one curing agent having at least two thiol groups, and 4) at least one basic catalyst.

This invention provides a readily-processable thermosetting, elastomeric sealant for glass installations. The sealant composition does not require the presence of isocyanate groups, thiram or manganese dioxide. The cured sealant forms a strong elastomeric seal between glass and a substrate material, with good adhesion and low permeability to gases and liquids.

The FIGURE is a side view of a multipane glass assembly sealed with an elastomeric seal of the invention.

In this invention, a seal is formed between glass and a substrate. By “glass”, it is meant any inorganic amorphous material having a glass transition temperature of at least 100° C. It preferably is substantially transparent to visible light. The glass may be colorless or tinted. A preferred type of glass is a silica glass, by which is meant a glass containing 50% or more by weight silica. Among the silica glasses are fused silica glass, soda-lime-silica glass, sodium borosilicate glass, lead oxide glass, aluminosilicate glass and the like. Another preferred type of glass is so-called “oxide glass”, which contains alumina and a minor amount of germanium oxide.

The glass may have one or more coatings on either or both of its main surfaces. Examples of such coatings include reflective coatings of various types, such as IR, UV or visible light reflective surfaces, IR absorbers, UV absorbers, tints or other coloring layers, and the like.

The glass may be a have a multi-layer construction. For example, the glass may consist of two or more glass layers bonded by one or more intermediate layers of an adhesive polymer.

The substrate can be any solid material, including, for example, a metal, a ceramic, another glass, an organic polymer, a lignocellulosic material such as wood, paper, cotton and the like or another biological or natural material. An organic polymer may be, for example, a synthetic or biological-origin polymer, and may be a thermoplastic or a thermoset.

In specific embodiments, the glass forms a window for a vehicle, building or other construction and the substrate is a frame element to which the window is affixed. The frame element may be a vehicle frame structure (or a part thereof). The frame element may be a window sash, door stile or other structural support to which the window is affixed.

In other specific embodiments, the substrate is a spacer for a multi-pane glass assembly. Such a multi-pane assembly comprises at least one pair of substantially parallel glass sheets. The glass sheets are separated from each other by one or more peripheral spacers positioned between the glass sheets at or near at least one edge. A multi-pane assembly may contain any larger number of substantially parallel glass sheets, with each adjacent pair being separated by a peripheral spacer.

A representation of a multi-pane assembly is shown in the FIGURE. In the FIGURE, substantially parallel glass panes 1 are separated by spacer 2 near edge 11, defining space 4 between the two glass panes 1. As is typical, spacer 2 is recessed slightly from edge 11, leaving a cavity 8 that is defined by the interior faces 10 of each of panes 1 and the exterior surface 9 of spacer 2. Spacer 2 typically is positioned along the substantial length of edge 11 of glass panes 1, and more typically spacers such as spacer 2 will be positioned about the entire periphery of glass panes 1. Sealant 5 of this invention is bonded to said edge 11 of the glass sheets 1 and to spacer 2, forming a seal between each of glass panes 1 and spacer 2, and between glass panes 1. As shown, sealant 5 occupies cavity 8 defined by the interior faces 10 of each of panes 1 and the exterior surface 9 of spacer 2.

In the particular embodiment shown in the FIGURE, spacer 2 is hollow, and is filled with optional desiccant 6. Desiccant 6 often is provided to absorb moisture from the gas contained within space 4. Space 4 is typically filled with a gas such as air, nitrogen, helium argon, xenon and the like.

Also shown in the FIGURE are primary sealants 3, which are optional but are often included in insulating glass units. Primary sealants 3 are closest to the air gap between glass sheets 2 and are generally present to keep moisture vapor and gasses from moving in and out of space 4. Primary sealant 3 is preferably polyisobutylene, but may be another polymer having barrier properties.

Sealant 5 is a reaction product of a polyene compound, an epoxy resin and a curing agent that contains thiol groups.

The polyene compound has at least two aliphatic carbon-carbon double bonds (“ene groups”) capable of engaging in a thiol-ene addition reaction. At least one of these ene groups is spaced apart from each of the other ene groups by a flexible aliphatic spacer group having a weight of at least 1000 atomic mass units, preferably at least 2000 atomic mass units. It is preferred that each of these ene groups is spaced apart from each of the others by such a flexible aliphatic spacer group. The ene groups preferably are terminal, i.e., at the ends of the molecular chains.

The polyene preferably has no more than 8, more preferably no more than 6, still more preferably no more than 4, ene groups.

The ene groups are aliphatic or, less preferably, alicyclic carbon-carbon double bonds in which a hydrogen atom is bonded to at least one of the carbon atoms. The carbon-carbon double bonds can take the form:

—RC═CR′R″

wherein R, R′ and R″ are independently hydrogen or an organic substituent, which organic substituent may be substituted, provided at least one of R, R′ and R″ is a hydrogen atom. Any of R, R′ and R″ may be, for example, alkyl or substituted alkyl group having up to 12, preferably up to 4 and more preferably up to 3 carbon atoms. R is preferably hydrogen or methyl. It is preferred that R′ and R″ are each hydrogen and more preferred that R, R′ and R″ are all hydrogen.

In some embodiments, the ene groups are provided in the form of terminal α,β-unsaturated carboxylate groups, such as, for example, acrylate (—O—C(O)—CH═CH₂) groups or methacrylate (—O—C(O)—C(CH₃)=CH₂) groups. In some embodiments, the ene groups are terminal vinyl (—CH═CH₂) groups. The vinyl groups may be vinylaryl groups, in which the vinyl group is bonded directly to a ring carbon of an aromatic ring such as a phenyl ring. In some embodiments, the ene groups are terminal allyl (—CH₂—CH═CH₂) groups. The polyene compound may have ene groups of different types, or all of the ene groups can be the same.

The spacer groups each have a weight of at least 1000 atomic mass units, preferably at least 1500 atomic mass units, more preferably at least 2000 atomic mass units, still more preferably at least 3000 atomic mass units and in some embodiments at least 4000 atomic mass units. The weight of the flexible spacer groups may be as much as 20,000, and preferably is up to 12,000, more preferably up to 8000. The spacer groups each preferably include at least one chain having a mass of at least 1000 atomic mass units which, upon curing, produces in the resulting elastomer an elastomeric phase having a glass transition temperature of no greater than −20° C., preferably no greater than −35° C. and more preferably no greater than −40° C.

The spacer groups are aliphatic. Preferred aliphatic spacer groups include groups that contain sequences of linear or branched aliphatic carbon-carbon single bonds and/or non-conjugated double bonds, aliphatic ether bonds, aliphatic amine bonds, and/or other like bonds within their main chain. Such sequences may be, for example at least 5 atoms or at least 10 atoms in length and may be up to several hundred atoms in length. These sequences may be interspersed with various linking groups such as amide, urethane, urea, ester, imide carbonate and the like. These sequences may be interspersed with aromatic groups, provided that such aromatic groups preferably constitute no more than 25%, preferably no more than 5% of the weight of the aliphatic spacer group.

In preferred embodiments, each of the spacer groups contains an aliphatic polyether chain, which may form all or a portion such spacer groups. The aliphatic polyether chain preferably has a weight of at least 1500, more preferably at least 2000, still more preferably at least 3000, and in some embodiments at least 4000, to as much as 20,000, preferably up 12,000 and more preferably up to 8,000. The polyether chain may be, for example, a polymer of ethylene oxide, 1,2-propylene oxide, 1,2-butylene oxide, 2,3-butylene oxide, tetramethylene oxide, and the like. It has been found that polyether chains having side groups, such as, for example, polymers of 1,2-propylene oxide, 1,2-butylene oxide, 2,3-butylene oxide and the like, provide particularly good results in forming a phase-segregated polymer having good properties. An especially preferred spacer group contains a poly(1,2-propylene oxide) chain or a random propylene oxide-co-ethylene oxide chain in which the ethylene oxide chain contains up to 40%, preferably up to 25%, more preferably up to about 15%, by weight copolymerized ethylene oxide. Such especially preferred spacer groups may have terminal poly(ethylene oxide) segments, provided that such segments should not in the aggregate constitute more than 40%, preferably not more than 25% and more preferably not more than 15% of the total weight of the polyether.

A preferred class of polyene compounds are ene-terminated polyethers, especially ene-terminated polyethers having a molecular weight of at least 2000 (preferably at least 4000) up to 12,000 (preferably up to 8,000) and from 2 to 8, preferably 2 to 6 or 2 to 4 ene groups per molecule. There are several approaches to making those materials. One approach involves capping the hydroxyl groups of a polyether polyol with an ene compound that also has a functional group that reacts with a hydroxyl group to form a bond to the end of the polyether chain. Examples of such capping compounds include ene-containing isocyanate compounds include, for example, 3-isopropenyl-α,α-dimethylbenzylisocyanate (TMI) or isocyanatoethylmethacrylate (IEM). Ene-terminated polyethers also can be prepared by capping a polyether polyol with an ethylenically unsaturated halide such as vinyl benzyl chloride, an ethylenically unsaturated siloxane such as vinyltrimethoxylsilane, or an ethylenically unsaturated epoxide compound.

Another approach to making an ene-terminated polyether is to cap a polyether polyol as described before with a polyisocyanate compound, preferably a diisocyanate. The polyisocyanate may be, for example, an aromatic polyisocyanate such as diphenylmethane diisocyanate or toluene diisocyanate or an aliphatic polyisocyanate such as isophorone diisocyanate, hexamethylene diisocyanate, hydrogenated toluene diisocyanate, hydrogenated diphenylmethane diisocyanate, and the like. This produces a prepolymer that contains urethane groups and terminal isocyanate groups. The isocyanate groups are then capped by reaction with an isocyanate-reactive capping compound having a hydroxyl group and an ene group as described before. Examples of such isocyanate-reactive capping compounds include, for example, allyl alcohol, vinyl alcohol and hydroxyalkylacrylate and/or hydroxyalkylmethacrylate compounds such as hydroxyethylacrylate and hydroxyethylmethacrylate.

The epoxy resin is one or more materials having an average of at least 1.5, preferably at least 1.8, epoxide groups per molecule and an epoxy equivalent weight of up to 1000. The epoxy equivalent weight preferably is up to 500, more preferably is up to 250 and still more preferably up to 225. The epoxy resin preferably has up to eight epoxide groups and more preferably has 1.8 to 4, especially 1.8 to 3, epoxide groups per molecule.

The epoxy resin is preferably a liquid at room temperature, to facilitate easy mixing with other components. However, it is possible to use a solid (at 25° C.) epoxy resin, particularly is the epoxy resin is soluble in the polyene compound, and/or if the epoxy resin is provided in the form of a solution in a suitable solvent.

Among the useful epoxy resins include, for example, polyglycidyl ethers of polyphenolic compounds, by which it is meant compounds having two or more aromatic hydroxyl (phenolic) groups. One type of polyphenolic compound is a diphenol (i.e., has exactly two aromatic hydroxyl groups) such as, for example, resorcinol, catechol, hydroquinone, biphenol, bisphenol A, bisphenol AP (1,1-bis(4-hydroxylphenyl)-1-phenyl ethane), bisphenol F, bisphenol K, tetramethylbiphenol, or mixtures of two or more thereof. The polyglycidyl ether of such a diphenol may be advanced, provided that the epoxy equivalent weight is about 1000 or less, preferably about 250 or less and more preferably about 225 of less.

Suitable polyglycidyl ethers of polyphenols include those represented by structure (I)

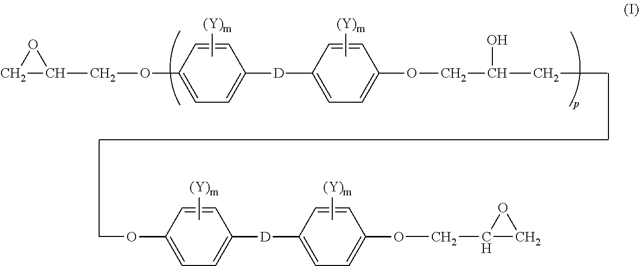

wherein each Y is independently a halogen atom, each D is a divalent hydrocarbon group suitably having from 1 to about 10, preferably from 1 to about 5, more preferably from 1 to about 3 carbon atoms, —S—, —S—S—, —SO—, —SO₂, —CO_{3—} —CO— or —O—, each m may be 0, 1, 2, 3 or 4 and p is a number such that the compound has an epoxy equivalent weight of up to 1000, preferably 170 to 500 and more preferably 170 to 225. p typically is from 0 to 1, especially from 0 to 0.5.

Fatty acid-modified polyglycidyl ethers of polyphenols, such as D.E.R. 3680 from The Dow Chemical Company, are useful epoxy resins.

Other useful polyglycidyl ethers of polyphenols include epoxy novolac resins. The epoxy novolac resin can be generally described as a methylene-bridged polyphenol compound, in which some or all of the phenol groups are capped with epichlorohydrin to produce the corresponding glycidyl ether. The phenol rings may be unsubstituted, or may contain one or more substituent groups, which, if present are preferably alkyl having up to six carbon atoms and more preferably methyl. The epoxy novolac resin may have an epoxy equivalent weight of about 156 to 300, preferably about 170 to 225 and especially from 170 to 190. The epoxy novolac resin may contain, for example, from 2 to 10, preferably 3 to 6, more preferably 3 to 5 epoxide groups per molecule. Among the suitable epoxy novolac resins are those having the general structure:

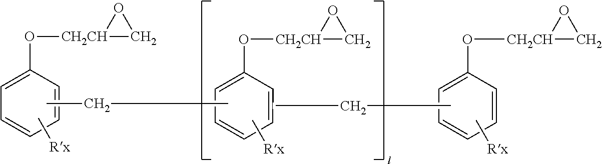

in which 1 is 0 to 8, preferably 1 to 4, more preferably 1 to 3, each R′ is independently alkyl or inertly substituted alkyl, and each x is independently 0 to 4, preferably 0 to 2 and more preferably 0 to 1. R′ is preferably methyl if present.

Other useful polyglycidyl ethers of polyphenol compounds include, for example, tris(glycidyloxyphenyl)methane, tetrakis(glycidyloxyphenyl)ethane, and the like.

Still other useful epoxy resins include polyglycidyl ethers of polyols, in which the epoxy equivalent weight is up to 1000, preferably up to 500, more preferably up to 250, and especially up to 200. These may contain 2 to 6 epoxy groups per molecule. The polyols may be, for example, alkylene glycols and polyalkylene glycols such as ethylene glycol, diethylene glycol, tripropylene glycol, 1,2-propane diol, dipropylene glycol, tripropylene glycol and the like as well as higher functionality polyols such as glycerin, trimethylolpropane, trimethylolethane, pentaerythritol, sorbitol and the like. These preferably are used together with an aromatic epoxy resin such as a diglycidyl ether of a biphenol or an epoxy novolac resin.

Still other useful epoxy resins include tetraglycidyl diaminodiphenylmethane; oxazolidone-containing compounds as described in U.S. Pat. No. 5,112,932; cycloaliphatic epoxides; and advanced epoxy-isocyanate copolymers such as those sold commercially as D.E.R.™ 592 and D.E.R.™ 6508 (The Dow Chemical Company) as well as those epoxy resins described, for example, in WO 2008/140906.

20 to 150 parts by weight of epoxy resin(s) may be provided to the reaction mixture, per 100 parts by weight of the ene compound(s) (component 1) above). The amount of epoxy resin, relative to the ene compound(s), can be varied as needed to adjust the properties of the elastomer. This ratio of epoxy resin to ene compound has been found to provide an elastomer having a combination of high elongation (at least 50%, preferably at least 100%) and good tensile strength (at least 2100 kPa (about 300 psi), preferably at least 3500 kPa (about 500 psi). Within this broad range, elongation generally decreases with an increasing amount of epoxy resin while tensile strength and modulus tend to increase. When the amount of epoxy resin is within the foregoing range, the epoxy resin tends to cure to form a discontinuous resin phase dispersed in a continuous phase constituted mainly by the cured ene compound (component 1)).

If a greater amount of the epoxy resin is provided, a phase inversion often is seen, in which the cured epoxy resin mainly constitutes a continuous phase of the final polymer, resulting in a low elongation product having properties similar to conventional toughened epoxy resins. To avoid forming such a low elongation material, it is preferred to provide no more than 125 parts by weight of epoxy resin(s) per 110 parts by weight of the ene compound(s) (component 1)). A more preferred amount is up to 105 parts by weight epoxy resin(s) per 100 parts by weight of the ene compounds (component 1)), and a still more preferred amount is up to 75 parts. The preferred lower amount is at least 25 or at least 40 parts by weight epoxy resin per 100 parts by weight of the ene compound(s) (component 1)).

The polythiol curing agent contains at least two thiol groups. The polythiol preferably has an equivalent weight per thiol group of up to 500, more preferably up to 200 and still more preferably up to 150. This polythiol compound may contain up to 8, preferably up to 4 thiol groups per molecule.

Among the suitable polythiol compounds are mercaptoacetate and mercaptopropionate esters of low molecular weight polyols having 2 to 8, preferably 2 to 4 hydroxyl groups and an equivalent weight of up to about 75, in which all of the hydroxyl groups are esterified with the mercaptoacetate and/or mercaptopropionate. Examples of such low molecular weight polyols include, for example, ethylene glycol, diethylene glycol, triethylene glycol, 1,2-propane diol, 1,3-propane diol, dipropylene glycol, tripropylene glycol, 1,4-butane diol, 1,6-hexane diol, glycerin, trimethylolpropane, trimethylolethane, erythritol, pentaerythritol, sorbitol, sucrose and the like.

Other suitable polythiol compounds include alkylene dithiols such as 1,2-ethane dithiol, 1,2-propane dithiol, 1,3-propanedithiol, 1,4-butane dithiol, 1,6-hexane dithiol and the like, trithiols such as 1,2,3-trimercaptopropane, 1,2,3-tri(mercaptomethyl)propane, 1,2,3-tri(mercaptoethyl)ethane, (2,3-di((2-mercaptoethyl)thio)1-propanethiol, and the like. Yet another useful polythiol compound is a mercapto-substituted fatty acid having at least 2 mercapto substituents on the fatty acid chains, such as, for example, that having the structure:

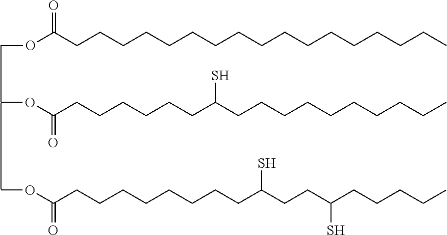

The amount of curing agent used can vary widely, depending on the properties that are wanted in the cured product, and in some cases depending on the type of curing reactions that are desired.

The amount of curing agent present in the reaction mixture can vary considerably. The maximum amount of curing agent typically provides up to 1.25 equivalents, preferably up to 1.15 equivalents and in some cases up to 1.05 equivalents of thiol groups per equivalent of ene and epoxy groups. Larger excesses of the curing agent tend to degrade polymer properties. Because the epoxy resin(s) can polymerize with themselves and in many cases the ene compound also is capable of self-polymerization, it is possible to provide a large excess of epoxy and/or ene groups in the reaction mixture. Thus, for example, as few as 0.1, as few as 0.25 or as few as 0.5 equivalents of thiol groups in the curing agent can be provided per equivalent of epoxy and ene groups.

In some embodiments, the amount of curing agent is close to stoichiometric, i.e., the total number of thiol hydrogen equivalents is somewhat close to the combined number of equivalents of epoxy and ene groups provided to the reaction mixture. Thus, for example, 0.75 to 1.25 equivalents, from 0.85 to 1.15 equivalents or from 0.85 to 1.05 equivalents of thiol groups can be provided by the curing agent per equivalent of epoxide and ene groups present in the reaction mixture.

The reaction mixture contains at least one basic catalyst. For purposes of this invention, a basic catalyst is a compound that is capable of directly or indirectly extracting a hydrogen from a thiol group to form a thiolate anion. In some embodiments, the basic catalyst does not contain thiol groups and/or amine hydrogens. The catalyst preferably is a material having a pKa of at least 5, preferably at least 10. Such a catalyst preferably is present even if an amine curing agent is present. The catalyst preferably also is a catalyst for the reaction of epoxide groups with an amine hardener, in embodiments in which an amine hardener is present.

Among useful types of catalysts include inorganic compounds such as salts of strong base and a weak acid, of which potassium carbonate and potassium carboxylates are examples, various amine compounds, and various phosphines.

Suitable amine various tertiary amine compounds, cyclic or bicyclic amidine compounds such as 1,8-diazabicyclo-5.4.0-undecene-7, catalysts include tertiary aminophenol compounds, benzyl tertiary amine compounds, imidazole compounds, or mixtures of any two or more thereof. Tertiaryaminophenol compounds contain one or more phenolic groups and one or more tertiary amino groups. Examples of tertiary aminophenol compounds include mono-, bis- and tris(dimethylaminomethyl)phenol, as well as mixtures of two or more of these. Benzyl tertiary amine compounds are compounds having a tertiary nitrogen atom, in which at least one of the substituents on the tertiary nitrogen atom is a benzyl or substituted benzyl group. An example of a useful benzyl tertiary amine compound is N,N-dimethyl benzylamine.

Imidazole compounds contain one or more imidazole groups. Examples of imidazole compounds include, for example, imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-undecylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]ethyl-s-triazine, 2,4-diamino-6-[2′-ethylimidazolyl-(1)′]ethyl-s-triazine, 2,4-diamino-6-[2′-undecylimidazolyl-(1)′]ethyl-s-triazine, 2-methylimidazolium-isocyanuric acid adduct, 2-phenylimidazolium-isocyanuric acid adduct, 1-aminoethyl-2-methylimidazole, 2-phenyl-4,5-dihydroxylmethylimidazole, 2-phenyl-4-methyl-5-hydroxymethylimidazole, 2-phenyl-4-benzyl-5-hydroxymethylimidazole, and compounds containing two or more imidazole rings obtained by dehydrating any of the foregoing imidazole compounds or condensing them with formaldehyde.

Other useful catalysts include phosphine compounds, i.e., compounds having the general formula R³₃P, wherein each R³ is hydrocarbyl or inertly substituted hydrocarbyl. Dimethylphenyl phosphine, trimethyl phosphine, triethylphosphine and the like are examples of such phosphine catalysts.

The basic catalyst is present in a catalytically effective amount. A suitable amount is typically from about 0.01 to about 10 moles of catalyst per equivalent of thiol and amine hydrogens in the curing agent. A preferred amount is 0.5 to 1 mole of catalyst per equivalent of thiol in the curing agent.

In addition to the foregoing ingredients, the reaction mixture may contain various other materials.

One other material that can be present is a free-radical initiator, and in particular a thermally decomposable free radical initiator that produces free radicals when heated to a temperature in the range of 50 to 160° C., especially 65 to 120° C. and more preferably 70 to 100° C. Such a thermally-decomposable free radical initiator compound may have a 10 minute half-life temperature of 50 to 120° C. The presence of the free radical initiator is preferred when the ene groups of the polyene compound are not easily curable via a cationic or anionic mechanism, as is often the case when the ene groups are vinyl, vinylaryl or allyl.

The presence of a free radical initiator can permit a dual-mechanism cure to take place, in which the ene reaction with a thiol takes place via a free radical mechanism, and the epoxy cure takes place via an anionic (base-catalyzed) mechanism. Such an approach permits the ene and epoxy reactions to take place sequentially, if desired, by subjecting the reaction mixture first to conditions that promote the formation of free radicals by the free radical initiator, and then to conditions sufficient to cure the epoxy resin component. Alternatively, both curing mechanisms can occur simultaneously by, for example, selecting a heat-activated free radical initiator, and exposing the reaction mixture to an elevated temperature sufficient to activate the free radical initiator and promote the epoxy curing reaction.

Certain ene compounds, in particular those having terminal acrylate and/or methacrylate ene groups, can homopolymerize in the presence of free radicals. Thus, in some embodiments, an excess of ene compounds having acrylate and/or methacrylate ene groups (over the amount of thiol and/or amine groups in the curing agent) can be provided in conjunction with a free radical initiator, to promote a certain amount of homopolymerization of the ene compound in addition to the ene/thiol and/or ene/amine curing reaction. In other embodiments, the ene compound contains, for example, vinyl and/or allyl ene groups, which do not homopolymerize to a significant extent under free radical conditions. In such a case, the presence of a free radical initiator may still be of benefit, as it allows for the dual cure mechanism in which the ene groups react with the thiol and/or amine groups via a free radical mechanism and the epoxy cures via a base-catalyzed mechanism.

Examples of suitable free-radical generators include, for example, peroxy compounds (such as, for example peroxides, persulfates, perborates and percarbonates), azo compounds and the like. Specific examples include hydrogen peroxide, di(decanoyl)peroxide, dilauroyl peroxide, t-butyl perneodecanoate, 1,1-dimethyl-3-hydroxybutyl peroxide-2-ethyl hexanoate, di(t-butyl)peroxide, t-butylperoxydiethyl acetate, t-butyl peroctoate, t-butyl peroxy isobutyrate, t-butyl peroxy-3,5,5-trimethyl hexanoate, t-butyl perbenzoate, t-butyl peroxy pivulate, t-amyl peroxy pivalate, t-butyl peroxy-2-ethyl hexanoate, lauroyl peroxide, cumene hydroperoxide, t-butyl hydroperoxide, azo bis(isobutyronitrile), 2,2′-azo bis(2-methylbutyronitrile) and the like.

A useful amount of free-radical initiator is 0.2 to 10 parts by weight per 100 parts by weight of ene compound(s).

Another optional component is one or more low equivalent weight ene compounds. Such compound(s) have one or more ene groups as described before and may have, for example, an equivalent weight per ene group of up to about 450, preferably up to about 250. Such low equivalent weight ene compounds can be produced, for example, by capping the hydroxyl groups of a low (up to 125, preferably up to 75) equivalent weight polyol with an unsaturated isocyanate compound such as 3-isopropenyl-α,α-dimethylbenzylisocyanate (TMI) or isocyanatoethylmethacrylate (IEM), an ethylenically unsaturated halide such as vinyl benzyl chloride, an ethylenically unsaturated siloxane such as vinyltrimethoxylsilane, an ethylenically unsaturated epoxide compound, or a hydroxyalkyl acrylate or methacrylate. Low equivalent weight ene compounds also can be produced by capping a polyisocyanate, preferably a diisocyanate, with an isocyanate-reactive capping compound having a hydroxyl group and an ene group as described before. Other useful low equivalent weight ene compounds include divinyl arene compounds such as divinyl benzene.

In some embodiments of the invention, mixtures of high and low equivalent weight ene compounds can be produced by (1) reacting an excess of a polyisocyanate with a polyether polyol, optionally in the presence of a chain extender, to form a quasi-prepolymer containing isocyanate terminated polyether compounds unreacted (monomeric) polyisocyanates and then (2) capping the isocyanate groups with an isocyanate-reactive capping compound having a hydroxyl group and an ene group as described before. This caps the prepolymer molecules and the remaining monomeric isocyanate compounds to produce a mixture of high and low equivalent weight ene compounds.

The reaction mixture may contain other materials in addition to those described above. Such additional materials may include, for example, one or more colorants, one or more include solvents or reactive diluents, one or more antioxidants, one or more preservatives, one or more fibers, one or more non-fibrous particulate fillers (including micron- and nano-particles), wetting agents and the like.

The reaction mixture preferably is substantially free of manganese dioxide, thiram and isocyanate compounds. Such compounds, if present at all, preferably constitute at most 1%, more preferably at most 0.5% of the weight of the reaction mixture. Most preferably the reaction mixture contains no measurable amount of any of these compounds.

To produce a seal, the reaction mixture is applied to an interface between and in contact with the glass and a substrate and then cured to form an elastomeric seal between the glass and the substrate.

To facilitate application, it is often convenient to formulate the reactants into a two-component system. The first component contains the epoxy resin and at least a portion of the polyene compound(s). The second component contains the thiol curing agent. It is often beneficial to formulate the first component to have a viscosity similar to that of the second component at the mixing temperature (such as, for example, the higher viscosity component having a viscosity within 50%, more preferably within 25%, of that of the lower viscosity component) to facilitate mixing. Because the polyene compound tends to be reactive ingredient having the highest viscosity, the first component tends to have a much higher viscosity than the second component. One way to make the viscosities of the components similar is to divide the polyene compound between the first and second components, so some of the polyene compound is in each of the first and second components.

It is generally preferred to formulate the basic catalyst into the thiol compound to prevent premature reaction of the ene and/or epoxy compounds. Other ingredients can be formulated into either or both of the components, provided such compounds do not undesirably react therewith.

The mixing and application can be done in any convenient manner. In the preferred case in which the ingredients are formulated into two components, the components are simply combined at ambient temperature or any desirable elevated temperature, deposited onto the interface between glass and substrate, and allowed to react. The mixing of the components can be done in any convenient way, depending on the particular application and available equipment. Mixing of the components can be done batchwise, mixing them by hand or by using various kinds of batch mixing devices, followed by application by brushing, pouring, applying a bead and/or in other suitable manner. The two components can be packaged into separate cartridges and simultaneously dispensed through a static mixing device to mix and apply them, typically as a bead, onto the interface.

Spraying methods are also useful. In a spraying method, the individual ingredients or formulated components are brought under pressure to a mixhead, where they are combined and dispensed under pressure to the interface between glass and substrate.

Other continuous metering and dispensing systems also are useful to mix and dispense the reaction mixture and apply it to the interface between glass and substrate.

Curing in many cases proceeds spontaneously at room temperature (about 20° C.), and in such cases can be effected without application of heat. Therefore, a wide range of curing temperatures can be used, such as, for example, a temperature from 0 to 180° C. The curing reaction is generally exothermic, and a corresponding temperature rise may occur.

A faster and/or more complete cure often is seen at higher temperatures, and for that reason it may be desirable in some embodiments to apply heat to the applied reaction mixture. This can be done, for example, by (a) heating one or more of the starting materials prior to mixing it with the others to form the reaction mixture and/or (b) heating the reaction mixture after it has been formed by combining the raw materials. If an elevated temperature cure is performed, a suitable elevated curing temperature is 35 to 180° C. A more preferred elevated curing temperature is 50 to 120° C. and a still more preferred curing temperature is 50 to 90° C.

In some embodiments, curing can be performed by exposing the reaction mixture to free radicals and/or conditions that generate free radicals. This can be done, if desired, in addition to performing an elevated temperature cure. Free radicals can be provided in various ways. In some embodiments, the reaction mixture is exposed to a light source, preferably a source of ultraviolet light such as a mercury discharge lamp or a UV-producing LED. The ultraviolet light source may provide UV radiation at an intensity of, for example, 10 mW/cm² to 10 W/cm². In other embodiments, the reaction mixture is exposed to a plasma. In still other embodiments, the free radicals are generated by the decomposition of a free radical initiator compound as described before. In the last case, free radicals can be generated thermally by exposing the reaction mixture to an elevated temperature, thereby promoting a free radical curing mechanism as well as accelerating the reaction of the epoxy resin(s) with the curing agent.

Free radical conditions tend to promote the ene-thiol curing reaction but not a epoxy curing reaction. Therefore, it is usually necessary to provide a catalyst for the epoxy curing reaction even if a free radical cure is performed.

In some cases, especially when the ene compound contains acrylate and/or methacrylate ene group, free radical conditions also can promote a homopolymerization of the ene compound(s). When it is desired to promote such a homopolymerization, the reaction mixture preferably includes at least one ene compound having acrylate and/or methacrylate ene groups, and also preferably includes an excess of ene and epoxy groups, relative to the amount of curing agent, such as at least 1.25, up to as many as 10, equivalents of ene and epoxy groups per equivalent of thiol groups in the curing agent. If the homopolymerization of the ene is not desired, it is preferred that the ene compounds are devoid of ene groups such as acrylate and methacrylate groups, which homopolymerize under free radical conditions.

The cured polymer is elastomeric. It typically has an elongation to break of at least 100%, as determined according to ASTM D1708. Elongation to break may be as much as 1000% or more. A typical elongation is 100 to 400%, especially 100 to 250%. Tensile strength is often at least 1000 kPa (about 150 psi), at least 2000 kPa (about 300 psi), in some embodiments at least 3500 kPa (about 500 psi), and in especially preferred embodiments at least 7000 kPa (about 1000 psi). Tensile strength may be 28,000 kPa (about 4000 psi) or higher, but is more typically up to 21000 kPa (about 3000) psi or up to 14000 kPa (about 2000 psi). The elastomer in many embodiments has a Shore A hardness of 60 to 95, more typically 70 to 95 and still more typically 70 to 90, although harder elastomers can be produced. An advantage of this invention is that properties can be tailored through the selection of starting materials, the ratios of starting materials, and to some extent the manner of cure.

Multi-pane glass assemblies made in accordance with the invention are useful as insulating glass units, as solar modules, and the like.

The following examples are provided to illustrate the invention, but not limit the scope thereof. All parts and percentages are by weight unless otherwise indicated.

### EXAMPLE 1-4

### A. Synthesis of Acrylate-Terminated Polyether

74.5 g (428 mmol) toluene diisocyanate (TDI, 80/20 mixture of 2,4- and 2,6-isomers) is charged to a dry 2 L 4-neck round bottom flask equipped with overhead stirring, temperature control probe, addition funnel, and nitrogen inlet. The flask and its contents are heated to 80° C., and 827 g (207 mmol) of a 4000 molecular weight, nominally difunctional poly(propylene oxide) diol is added. The solution is stirred for 30 minutes after the diol is added. A drop of dibutyltin dilaurate is added and the reaction stirred for an additional 2 hours. The product is an isocyanate-terminated prepolymer having an isocyanate content of 2.04% by weight, as determined by titration.

881.2 grams of the prepolymer is brought to a temperature of 45° C. 54.3 g (467.6 mmol) of hydroxyethylacrylate (95%) and a drop of dibutyltin dilaurate are added. The reaction mixture is stirred at 45° C. until no measurable isocyanate groups remain as observed by FT-IR. The resulting product is a polyether capped with two terminal acrylate (—O—C(O)—CH═CH₂) groups per molecule.

### B. Production of Phase-Segmented Elastomer

Phase-segmented Elastomer Examples 1-4 are prepared from the acrylate-terminated polyether produced in A above and other ingredients as indicated in Table 1 below. In each case, the acrylate-terminated polyether is blended with the epoxy resin on a high-speed laboratory mixture until homogeneous. Separately, trimethylol propane tris(mercaptopropionate) (Sigma Aldrich technical grade) is mixed with 1,8-diazabicyclo[5.4.0]undec-7-ene (DBU, Sigma Aldrich technical grade). The thiol/catalyst mixture is then mixed with the acrylate-terminated prepolymer/epoxy resin mixture on the high speed mixer to produce a clear mixture. A portion of the mixture is poured into a mold warmed to 50° C. The filled mold is then placed in a 50° C. oven overnight. A tack-free plaque is obtained.

The tensile strength, tensile modulus and elongation at break are measured per ASTM D1708. The Shore A hardness is measured according to ASTM D2240. Results are as indicated in Table 1.

TABLE 1

| | Parts by weight | | | |
|---|---|---|---|---|
| | Ex. 1 | Ex. 2 | Ex. 3 | Ex. 4 |
| Ingredient | | | | |
| Acrylate-terminated | 20 | 20 | 15 | 35 |
| polyether | | | | |
| DER 383 ® Epoxy resin | 4.1 | 6.667 | 9.59 | 35 |
| Trimethylolpropane | 4.39 | 6.29 | 8.1 | 28.22 |
| tri(thiopropionate) | | | | |
| DBU catalyst | 0.017 | 0.024 | 0.031 | 0.107 |
| Properties | | | | |
| Tensile Str., kPa (psi) | 2650 (385) | 3300 (477) | 6975 (1012) | 11,175 (1621) |
| Elongation, % | 187 | 159 | 122 | 120 |
| Tensile Modulus, kPa (psi) | 3515 (510) | 4710 (683) | 10915 (1583) | 26025 (3775) |
| Shore A hardness | 63 | N.D. | 79 | 89 |

DER 383 Epoxy resin is a diglycidyl ether of bisphenol A having an epoxy equivalent weight of about 180.

In all cases, the tensile and elongation properties are suitable for use as a glass sealant. As the amount of epoxy resin increases through this series of examples, tensile strength and hardness increase and elongation decreases. This data demonstrates the ability to tailor the properties of the elastomer through variations in the ratios of raw materials, without disrupting the desirable low temperature curing properties.

A 10 cm×10 cm section of each of these cured plaques are placed in distilled water and heated at 70° C. for 500 hours. The samples are then dried and its tensile strength is remeasured. The tensile strength in each case shows no change or a small (up to about 5%) change, indicating excellent hydrolytic stability and further indicating that the cured material has a low moisture vapor transmission rate.

When used to seal the edge of a multi-pane glass assembly, each of Examples 1 through 4 demonstrates excellent adhesion to the glass and spacer, and forms a high quality seal.

### EXAMPLES 5-8

An acrylate-terminated polyether having an equivalent weight per terminal acrylate group of 1947 is made in the general manner described in Example 1A. Elastomer Examples 5-8 are made from this acrylate-terminated polyether, using formulations as set forth in Table 2 below. In each case, the acrylate-terminated polyether is mixed with the epoxy resin in a high-speed laboratory mixture, and then a mixture of the thiols and catalyst are stirred in. A portion of the resulting reaction mixture is poured into a mold warmed to 50° C. The filled mold is then placed in a 50° C. oven overnight. A second portion of the reaction mixture is cured overnight in an 80° C. oven. A tack-free plaque is obtained in each case. Tensile strength, elongation, tensile modulus and Shore A hardness are as reported in Table 2.

TABLE 2

| | Parts by weight | | | |
|---|---|---|---|---|
| | Ex. 5 | Ex. 6 | Ex. 7 | Ex. 8 |
| Ingredient | | | | |
| Acrylate-terminated | 20 | 50 | 35 | 35 |
| polyether | | | | |
| DER 383 Epoxy resin | 4.1 | 31.97 | 35 | 65 |
| Trimethylolpropane | 1.97 | 6.29 | 14.11 | 14.39 |
| tri(thiopropionate) | | | | |
| Ethylene glycol | 2.19 | 13.50 | 12.65 | 12.91 |
| di(thiopropionate) | | | | |
| DBU catalyst | 0.055 | 0.278 | 0.291 | 0.198 |
| Properties, 80° C. cure | | | | |
| Tensile Str., kPa (psi) | 3010 (437) | 9045 (1312) | 10570 (1533) | 19300 (2800) |
| Elongation, % | 453 | 354 | 300 | 258 |
| Tensile Modulus, kPa (psi) | 1965 (285) | 6075 (881) | 14730 (2137) | 36400 (5281) |
| Shore A hardness | N.D. | N.D. | 80-85 | N.D. |
| Tear Strength, N/mm | N.D. | N.D. | 30 | N.D. |
| Properties, 50° C. cure | | | | |
| Tensile Str., kPa (psi) | 3520 (511) | 6650 (965) | 8585 (1245) | 9425 (1367) |
| Elongation, % | 539 | 387 | 324 | 213 |

The abrasion resistance of elastomer Example 7 is evaluated for 1000 cycles on a Taber abrader equipped with 1 kg weight and H22 wheels. Example 7 loses less than 100 mg of mass.

Again, the material properties of Examples 5-8 are suitable for glass sealing applications. In Examples 5-8, the blend of thiols results in a lower average thiol functionality (about 2.5) than in Examples 1-4. This change results in higher elongations and lower tensile strengths (at equivalent epoxy resin content) than seen in Examples 1-4, and indicates that further tailoring of properties can be achieved through selection of the functionality of the thiol curing agent.

When used to seal the edge of a multi-pane glass assembly, each of Examples 5 through 8 demonstrates excellent adhesion to the glass and spacer, and forms a high quality seal.

### EXAMPLES 9-12

An acrylate-terminated polyether having an equivalent weight per terminal acrylate group of 1230 is made in the general manner described in Example 1A, by capping a 2000-molecular weight poly(tetramethylene oxide) diol with TDI to form an isocyanate-terminated prepolymer, and then capping the isocyanate groups with hydroxyethylacrylate.

Elastomer Examples 9-12 are made from this acrylate-terminated polyether, using formulations as set forth in Table 3 below. In each case, the acrylate-terminated polyether is mixed with the epoxy resin in a high-speed laboratory mixture, and then a mixture of the thiol and catalyst are stirred in. A portion of the resulting reaction mixture is poured into a mold warmed to 80° C. The filled mold is then placed in an 80° C. oven overnight. A tack-free plaque is obtained. Tensile strength and elongation are as reported in Table 3.

TABLE 3

| | Parts by weight | | | |
|---|---|---|---|---|
| | Ex. 9 | Ex. 10 | Ex. 1 | Ex. 12 |
| Ingredient | | | | |
| Acrylate- | 20 | 20 | 20 | 20 |
| terminated | | | | |
| polyether | | | | |
| Diglycidyl | 1.05 | 2.22 | 5.0 | 8.57 |
| ether of 1,4- | | | | |
| butane diol | | | | |
| Pentraerythritol | 3.26 | 4.67 | 8.03 | 12.35 |
| tetra(thio- | | | | |
| propionate) | | | | |
| DBU catalyst | 0.013 | 0.015 | 0.014 | 0.015 |
| Properties | | | | |
| Tensile Str., | 3565 (517) | 1730 (251) | 1565 (227) | 1165 (169) |
| kPa (psi) | | | | |
| Elongation, % | 350 | 313 | 322 | 174 |

In this series of examples, both tensile strength and elongation tend to decrease with increasing epoxy resin content. This is believed to be due to the use of an aliphatic epoxy resin instead of the aromatic type used in Examples 1-8. In Examples 9-12, the higher functionality thiol is believed to offset some of the loss of properties due to the use of the aliphatic epoxy resin. Elastomers 9-12 all have adequate tensile and elongation properties to function as glass sealants. When used to seal the edge of a multi-pane glass assembly, each of Examples 9-12 also demonstrate excellent adhesion to the glass and spacer, and forms a high quality seal.

1. A process for forming a seal between glass and a substrate, comprising:
a) forming a reaction mixture containing 1) at least one ene-terminated poly(alkylene oxide) having a molecular weight of 4,000 to 8,000, 2 to 6 aliphatic carbon-carbon double bonds capable of reaction with a thiol group, wherein at least one of such aliphatic carbon-carbon double bonds is separated from each other such aliphatic carbon-carbon double bond by an aliphatic spacer group having a weight of at least 1000 atomic mass units, 2) from 20 to 150 parts by weight, per 100 parts by weight of component 1), of at least one epoxy resin having an average of at least 1.5 epoxide groups per molecule and an epoxy equivalent weight of up to 1000, 3) at least one curing agent having at least at least two thiol groups and 4) at least one basic catalyst reaction,
b) applying the reaction mixture to an interface between and in contact with said glass and said substrate;
c) curing the reaction mixture to form an elastomeric seal between the glass and the substrate.

2. A process for producing an edge seal for a multi-pane glass assembly, wherein the multi-pane glass assembly comprises at least one pair of substantially parallel glass sheets, glass sheets of said pair being separated from each other and by one or more spacers positioned between the pair of glass sheets at or near at least one edge of the glass sheets; comprising
a) applying a curable reaction mixture to said at least one edge of the pair of glass sheets and into contact with each of the pair of glass sheets and the spacer(s) separating said pair of glass sheets and
b) curing the curable reaction mixture to form an elastomeric edge seal between the pair of glass sheets and adherent to the spacer(s) separating the pair of glass sheets;
wherein the curable reaction mixture contains 1) at least one ene-terminated poly(alkylene oxide) having a molecular weight of 4,000 to 8,000, 2 to 6 aliphatic carbon-carbon double bonds capable of reaction with a thiol group, wherein at least one of such aliphatic carbon-carbon double bonds is separated from each other such aliphatic carbon-carbon double bond by an aliphatic spacer group having a weight of at least 1000 atomic mass units, 2) from 20 to 150 parts by weight, per 100 parts by weight of component 1), of at least one epoxy resin having an average of at least two epoxide groups per molecule and an epoxy equivalent weight of up to 1000, 3) at least one curing agent having at least two thiol groups and 4) at least one basic catalyst.

3. (canceled)

4. The process of claim 2, wherein the epoxy resin has an epoxy equivalent weight of up to 250.

5. The process of claim 2, wherein the epoxy resin includes at least one polyglycidyl ether of a polyphenol compound.

6. The process of claim 2, wherein the curing agent includes at least one polythiol compound that contains from 2 to 4 thiol groups, or a mixture of two or more polythiol compounds that each contain 2 to 4 thiol groups, and a thiol equivalent weight of 50 to 250.

7. The process of claim 2, wherein the reaction mixture further includes at least one thermally-decomposable free radical initiator compound, and step c) includes a free-radical reaction of the polyene and the thiol curing agent, and a base-catalyzed reaction between the epoxy resin and the thiol curing agent.

8. The process of claim 2 wherein the terminal aliphatic carbon-carbon double bonds are acrylate groups.

9. A multi-pane glass assembly comprising at least one pair of substantially parallel glass sheets, the glass sheets of said pair being separated from each other and by one or more spacers positioned between the pair of glass sheets at or near at least one edge of the glass sheets, and an elastomeric edge seal bonded to said edge of the glass sheets and the spacer(s),
wherein the elastomeric edge seal is a polymer formed by curing a curable reaction mixture containing 1) at least one ene-terminated poly(alkylene oxide) having a molecular weight of 4,000 to 8,000, 2 to 6 aliphatic carbon-carbon double bonds capable of reaction with primary amine, secondary amine and/or a thiol group, wherein at least one of such aliphatic carbon-carbon double bonds is separated from each other such aliphatic carbon-carbon double bond by an aliphatic spacer group having a weight of at least 1000 atomic mass units, 2) from 20 to 150 parts by weight, per 100 parts by weight of component 1), of at least one epoxy resin having an average of at least two epoxide groups per molecule and an epoxy equivalent weight of up to 1000, 3) at least one curing agent having at least two amine hydrogens, at least two thiol groups, or at least one amine hydrogen and at least one thiol group and, if component c) does not include a curing agent having at least one amine hydrogen, 4) at least one basic catalyst.

10. (canceled)

11. The glass assembly of claim 9, wherein the epoxy resin has an epoxy equivalent weight of up to 250 and includes at least one polyglycidyl ether of a polyphenol compound.

12. The glass assembly of claim 9, wherein the curing agent includes at least one polythiol compound that contains from 2 to 4 thiol groups, or a mixture of two or more polythiol compounds that each contain 2 to 4 thiol groups, and has a thiol equivalent weight of 50 to 250.

13. The glass assembly of claim 9, wherein the reaction mixture further includes at least one thermally-decomposable free radical initiator compound and the curing step includes a free-radical reaction of the polyene and the thiol curing agent, and a base-catalyzed reaction between the epoxy resin and the thiol curing agent.

14. The glass assembly of claim 9 wherein the terminal aliphatic carbon-carbon double bonds are acrylate groups.
